(19) United States
(12) Patent Application Publication
(10) Pub. No.: US 2010/0229600 A1
(43) Pub. Date: Sep. 16, 2010

(54) METHOD FOR MANUFACTURING GLASS MOLDING DIE AND METHOD FOR MANUFACTURING MOLDED GLASS ARTICLE

(75) Inventors: Naoyuki Fukumoto, Amagasaki-shi (JP); Shunichi Hayamizu, Amagasaki-shi (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 12/719,986

(22) Filed: Mar. 9, 2010

(30) Foreign Application Priority Data
Mar. 13, 2009 (JP) JP2009-061070

(51) Int. Cl. C03B 11/00; B22C 9/12; B22C 3/00

(52) U.S. Cl. 65/66; 164/17; 164/14

(57) ABSTRACT

Provide is a method for manufacturing a glass molding die in which deformation of a molding die in a process after machining is restrained without increased wear of a bit, and a method for manufacturing a molded glass article utilizing the glass molding die. A plated layer made of Ni—P plating is formed on the surface of a substrate, a rough machining is performed on the plated layer to form a shape similar to the desired final shape, the plated layer is then subjected to a thermal treatment, and finally finish machining is performed to form the desired final shape.

This application is based on Japanese Patent Application No. 2009-061070 filed on Mar. 13, 2009, in Japanese Patent Office, the entire content of which is hereby incorporated by reference.

### TECHNICAL FIELD

The present invention relates to a method for manufacturing a glass molding die and a method for manufacturing a molded glass article using the glass molding die.

### BACKGROUND

Heretofore, known is a method for manufacturing a glass molding die to mold glass optical elements represented by a glass lens, in which molding die a plated layer containing Ni—P plating is formed on the surface of a substrate made of various heat resistant alloys or ceramics and the plated layer is machined and finished by a diamond bit to be a desired surface shape.

However, there was a problem that cracks were generated by a thermal shock at the time of molding in the case where a molding die manufactured by such method is utilized, as is, for molding glass.

Therefore, proposed is a method in which a molding die is subjected to a thermal treatment at a predetermined temperature in advance (for example, refer to Japanese Patent Application Publication Nos. 11-157852 and 2008-150226). In Japanese Patent Application Publication No. 11-157852, described is a method in which a plated layer is subjected to a thermal treatment at a high temperature of 400-500° C. after having been machined and finished to be a desired surface shape without a thermal treatment before machining of the plated layer. In Japanese Patent Application Publication No. 2008-150226, described is a method in which a plated layer is subjected to a thermal treatment at a high temperature not lower than 270° C. before machining of the plated layer.

However, a plated layer of Ni—P plating is originally an amorphous substance; however, crystallization proceeds at high temperature in a thermal treatment process or in a molding process of a glass lens, whereby the plated layer is hardened and the density and volume are also varied. In particular, since the temperature of a molding die is high in the case of glass molding, a plated layer is deformed in a molding process resulting in deformation of the molding die surface unless crystallization of a plated layer is sufficient in a thermal treatment process.

Therefore, when the method in which a thermal treatment at high temperature is performed after machining and finishing a plated layer to be a desired surface shape as described in Japanese Patent Application Publication No. 11-157852 is employed, there is a problem that a plated layer which is once finished is deformed by a heat treatment after being machined. Further, there is also a problem of the surface roughness being increased by crystallization of a plated layer caused by a thermal treatment.

On the other hand, when the method in which a plated layer is subjected to a thermal treatment before being machined to proceed crystallization as described in Japanese Patent Application Publication No. 2008-150226 is employed, it is possible to restrain generation of cracks at the time of machining; however, there is a problem that it is difficult to finish the plated layer into a desired surface shape and roughness because a bit easily wears, cutting the plated layer hardened by crystallization.

### SUMMARY

The invention has been made in view of the above-described technical problems, and an object of the invention is to provide a method for manufacturing a glass molding die, which does not cause a bit to wear much, has a shape with high precision and small surface roughness, and can reduce deformation of a shape of a molding die in processes after having been machined, and a method for manufacturing a molded glass article capable of preparing a molded glass article having high shape precision and small surface roughness.

In view of forgoing, one embodiment according to one aspect of the present invention is a method of manufacturing a glass molding die, the method comprising the steps of:

forming a plated layer made of Ni—P plating on a surface of a substrate;

rough machining the plated layer to have a shape similar to a desired final shape;

thermal treating the rough machined plated layer to harden; and

finish machining the hardened plated layer to have the desired final shape.

According to another aspect of the present invention, another embodiment is a method for manufacturing a molded glass article, the method comprising the step of:

compression molding glass material to form the molded glass article, using a glass molding die,

wherein the glass molding die is manufactured by a method, for manufacturing a glass molding die, including the steps of:

forming a plated layer made of Ni—P plating on a surface of a substrate;

rough machining the plated layer to have a shape similar to a desired final shape;

thermal treating the rough machined plated layer to harden; and

finish machining the hardened plated layer to have the desired final shape.

According to another aspect of the present invention, another embodiment is a method for manufacturing a molded glass article, the method comprising the steps of:

dropping a molten glass drop on a first molding die; and

compression molding the dropped molten glass droplet with the first molding die and a second molding die which faces the first molding die,

wherein at least one of the first molding die and the second molding die is manufactured by a method, for manufacturing a glass molding die, including the steps of:

forming a plated layer made of Ni—P plating on a surface of a substrate;

rough machining the plated layer to have a shape similar to a desired final shape;

thermal treating the rough machined plated layer to harden; and

finish machining the hardened plated layer to have the desired final shape.

### BRIEF DESCRIPTION OF THE DRAWINGS

FIG. 1 is a flow chart to show an example of a method for manufacturing a glass molding die, of an embodiment according to the invention;

FIGS. 2a, 2 b, 2c, 2d, 2e and 2f are cross-sectional views to schematically show each step in FIG. 1;

FIG. 3 is a graph to show the relationship between the thermal treatment temperature and Vickers hardness with respect to a plated layer of an embodiment according to the invention;

FIG. 4 is a flow chart to show an example of a method, for manufacturing a molded glass article, of an embodiment according to the invention;

FIG. 5 is a schematic drawing of the state in step S203 to show an apparatus, for manufacturing a molded glass article, of an embodiment according to the invention; and

FIG. 6 is a schematic drawing of the state in step S205 to show an apparatus, for manufacturing a molded glass article, of an embodiment according to the invention.

### DETAILED DESCRIPTION OF THE PREFERRED EMBODIMENT

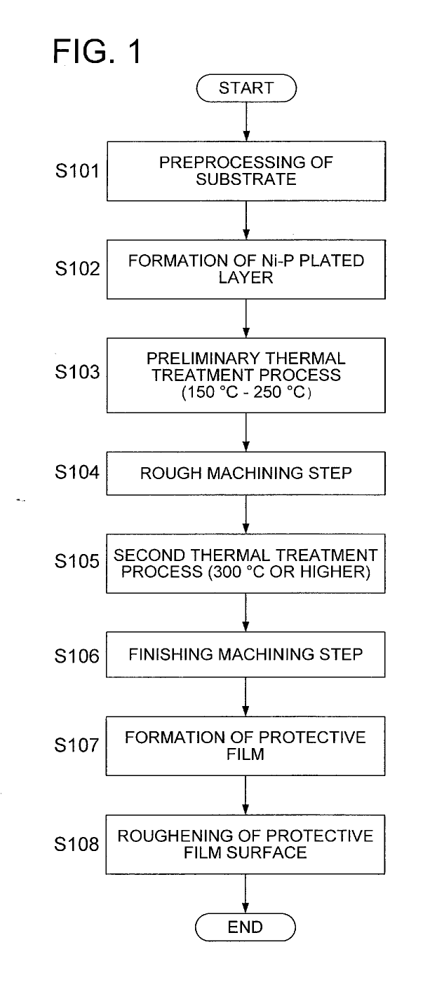

In the following, an embodiment of the invention will be detailed in reference to FIGS. 1-6; however, the invention is not limited to the embodiment.

(Manufacturing Method of Glass Molding Die)

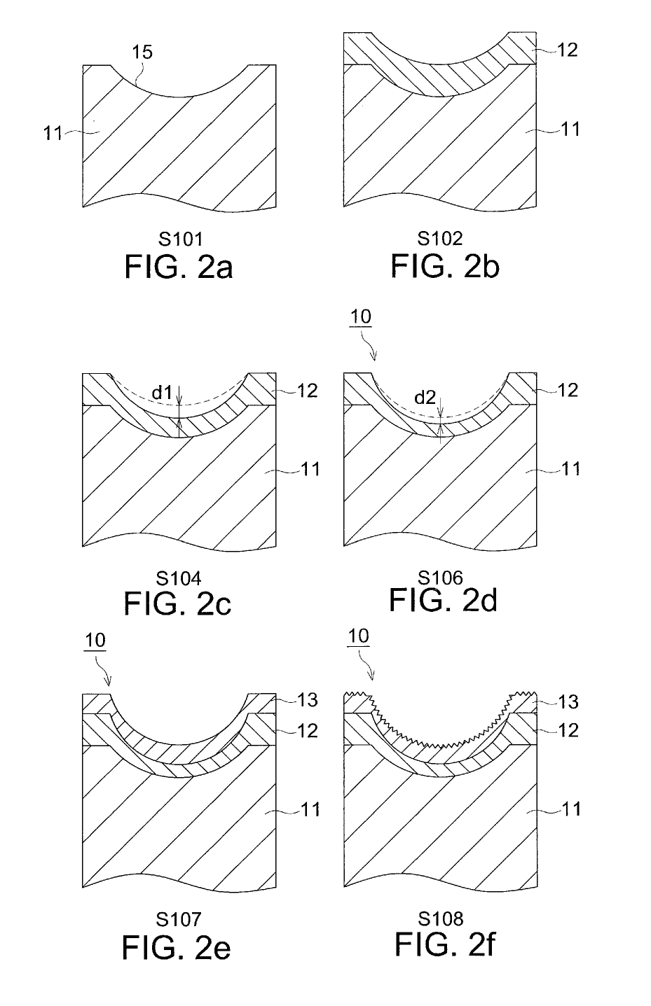

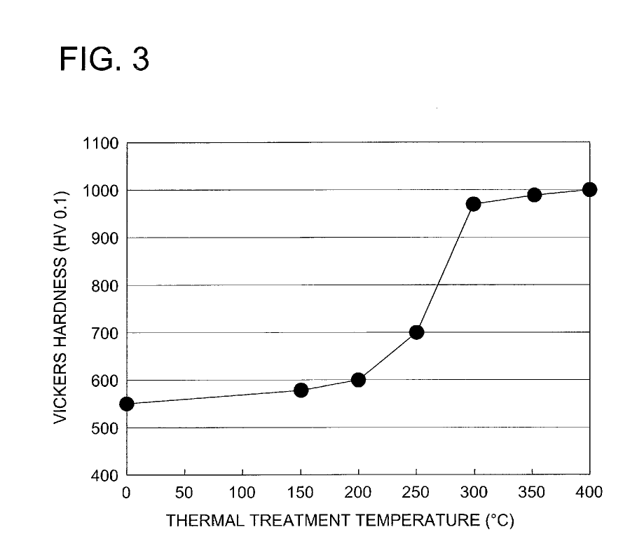

First, a method for manufacturing a glass molding die, in the embodiment will be explained in reference to FIGS. 1-3. FIG. 1 is a flow chart to show an example of a method for manufacturing a glass molding die, of the embodiment. FIGS. 2a, 2b, 2c, 2d, 2e and 2f are cross-sectional views to schematically show each step. FIG. 3 is a graph to show the relationship between the thermal treatment temperature and Vickers hardness (HV0.1) with respect to a plated layer. In the following, each step will be explained in order according to the flow chart of FIG. 1.

(Step S101: Preprocessing of Substrate)

First, formed surface 15 of substrate 11 is machined to be a predetermined shape corresponding to a molded glass article to be manufactured (FIG. 2a). The material of substrate 11 is not specifically limited and materials preferably utilized include, for example, various heat resistant alloys (such as stainless), super hard materials containing tungsten carbide as a primary component, various ceramics (such as silicon carbide and silicon nitride) and complex materials containing carbon.

The shape of formed surface 15 is also not specifically limited and may be any one of a flat surface, a convex surface and a concave surface. In view of making a the thickness of plated layer 12 to be formed in the next step be thinner and restraining peeling of plated layer 12, it is preferable to make a shape similar to the final shape corresponding to the surface shape of a molded glass article to be manufactured; however, it is not necessary to make the shape unnecessarily similar to the final shape because the machining cost will be increased. The difference between the final shape and the shape of a formed surface of substrate 11 in this step is preferably 1-50 μm and more preferably 2-20 μm at the thickest point.

(Step S102: Formation of Plated Layer)

Plated layer 12 made of Ni—P plating is formed on the surface (formed surface 15) of substrate 11 (FIG. 2b). Herein, Ni—P plating is non-electrolytic nickel plating containing P, and can be formed by a method well known in the art. As a plating solution, such as a plating solution utilizing hydrophosphorous acid as a reducing agent is utilized. It is enough for plated layer 12 to have the same thickness as a cutting amount for the succeeding machine to form a final shape; however, it is preferable for plated layer 12 to have the cutting amount for an iterative machining to achieve a shape with required precision. However, there may be a generation of defects such as peeling when it is unnecessarily thick. For this reason, the thickness of plated layer 12 is preferably thicker than the maximum value of differences between a shape of formed surface 15 of substrate 11 and the final shape by 1-50 μm. Therefore, the film thickness of plated layer 12 is preferably 2-100 μm and more preferably 3-70 μm.

(Step S103: Preliminary Thermal Treatment Process)

Next, plated layer 12 is subjected to a thermal treatment at a temperature lower than that of the thermal treatment process (step S105) described later. This process is not an indispensable process; however, since the residual stress of a plated layer is released by the preliminary thermal treatment process, it is possible to restrain generation of cracks in the plated layer at the time of a rough machining performed successively.

FIG. 3 is a graph to show the relationship between the thermal treatment temperature and Vickers hardness (HV0.1) with respect to plated layer 12. The thermal treatment was performed in a normal atmosphere, and the thermal treatment time was set to 1 hour. The Vickers hardness was measured at a test power of 0.98 N by use of Hardness Testing Machine (Model HM-113) manufactured by Akashi Corp. according to the definition of JIS Z 2244. The Vickers hardness of plated layer 12 before the thermal treatment is as low as approximately 550 HV0.1; however, the hardness is increased as the thermal treatment temperature rises, resulting in the hardness of approximately 970 HV0.1 with a thermal treatment at 300° C. The cause for this phenomenon is considered to be that a plated layer, which was amorphous before the thermal treatment, is crystallized to be a crystalline organization in which minute Ni₃P is dispersed in nickel (Ni).

The Vickers hardness of plated layer 12 after a preliminary thermal treatment process is preferably not larger than 700 HV0.1. Thus, machining can be easily performed without significant wear of a diamond bit.

Further, the thermal treatment temperature in a preliminary thermal treatment process is in the range of preferably 150-250° C. According to FIG. 3, the Vickers hardness of plated layer 12 having been subjected to a thermal treatment at 150-250° C. is 580-700 HV0.1. Thus, efficient release of residual stress in a plated layer is facilitated, and easy machining is possible without significant wear.

The thermal treatment may be performed either in an normal atmosphere or in a vacuum. Further, it may be performed in a normal atmosphere of nitrogen or inert gas. An apparatus for thermal treatment is not specifically limited, and an apparatus well known in the art such as an electric heater is appropriately utilized.

(Step S104: Rough Machining Step)

Next, plated layer 12 is machined to be a shape similar to the desired final shape by use of a bit such as a diamond bit (FIG. 2c). Since residual stress in plated layer 12 has been released since the preliminary thermal treatment has been performed, generation of cracks at the time of machining is restrained.

Machining may be performed by use of a machining apparatus and by a machining method which are well known in the art. The shape of plated layer 12 after a rough machining process is similar to the final shape, and the difference from the final shape is smaller than that before the rough machining process. Therefore, it is possible to decrease the cutting amount at the time of finish machining (step S106) which will be performed after hardening of plated layer 12, resulting in effectively restrained wear of bit. In view of effectively restraining wear of bit in the finish machining, maximum value d1 of the cutting amount of plated layer 12 in the rough machining is preferably not smaller than maximum value d2 of the cutting amount in the finish machining. It is preferable to make similar to the final shape as much as possible by rough machining; however, in consideration of deformation in the following second thermal treatment process, it is not preferable to make a shape unnecessarily similar to the final shape, because it will only raise the machining cost. Therefore, the difference between a shape after rough machining and the final shape is preferably 0.5-5 μm and more preferably 1-4 μm.

(Step S105: Second Thermal Treatment Process)

Next, plated layer 12 is hardened by a thermal treatment. By sufficiently proceeding crystallization of plated layer 12 in this thermal treatment process before performing the below-described finish machining (step S106), deformation, of the shape which has been finished in a finish machining, assumed to occur in the following processes will be controlled. Herein, to clearly distinguish this thermal treatment process from the above-described preliminary thermal treatment process (step S103), hereinafter, this process is referred to also as a second thermal treatment process.

As shown in FIG. 3, the Vickers hardness of plated layer 12 is greatly increased up to 970 HV0.1 from 550 HV0.1 when a thermal treatment at 300° C. is performed, while the Vickers hardness in the case of performing a thermal treatment at 400° C. is 1,000 HV0.1 and the increase of Vickers hardness is little even when the thermal treatment temperature is raised up to 400° C. from 300° C. That is, it is considered that crystallization of plated layer 12 can be sufficiently made to proceed by performing the thermal treatment at a temperature of not lower than 300° C. Therefore, hardening of plated layer 12 by a thermal treatment can restrain deformation due to further progress of crystallization thereafter and can restrain deformation of a shape having been finished, in the finish machining in the following processes. In view of sufficiently proceeding crystallization to restrain deformation thereafter, the Vickers hardness of plated layer 12 after the second thermal treatment process is preferably not less than 900 HV0.1 and more preferably not less than 950 HV0.1.

On the other hand, when the temperature of thermal treatment is excessively high, there is a case of causing a problem of deterioration of plated layer 12 due to oxidation. In view of both prevention of deterioration due to oxidation and sufficient progress of crystallization, the temperature of thermal treatment in the second thermal treatment process is preferably in the range of 300-550° C. and more preferably in the range of 350-500° C. Further, the temperature is preferably set at the temperature equal to or higher than that of a molding die at the time of being utilized in practical molding.

Similar to the case of the preliminary thermal treatment process, the second thermal treatment may be performed either in a normal atmosphere or in a vacuum. Further, it may be performed in a normal atmosphere of nitrogen or inert gas. An apparatus for thermal treatment is not specifically limited, and an apparatus well known in the art such as an electric heater is appropriately utilized.

(Step S106: Finish Machining)

Plated layer 12 having been subjected to a thermal treatment in the second thermal treatment process is processed to be the desired final shape by use of a bit such as a diamond bit (FIG. 2d). Since plated layer 12 is hardened by the second thermal treatment process, however, has been machined to make a shape similar to the final shape by the above-described rough machining process (step S104), thereby wear of a bit can be restrained to minimum. Further, by performing a finish machining, the surface roughness of plated layer 12, which has been increased due to crystallization in the second thermal treatment process, can be decreased. The machining may be performed by a machining apparatus and a machining method, which are well known in the art. Maximum value d2 of the cutting amount at the time of finish machining is determined by a difference between the shape after rough machining and the final shape, and by a deformation amount in the second thermal treatment process. Generally, it is preferably 0.5-5 μm and more preferably 1-4 μm.

When the finish machining is completed, molding die 10 for molding glass is completed. Herein, step S107 and step S108 which will be explained below are preferably performed consecutive to the finish machining in view of achieving advantages to prevent deterioration of plated layer 12 and to prevent generation of residual air in a molded glass article.

(Step S107: Formation of Protective Film)

Protective film 13 is formed on plated layer 12 (FIG. 2e). This step is not necessarily indispensable; however, deterioration of plated layer 12 due to oxidation can be restrained by forming protective film 13 on plated layer 12.

Preferable materials for protective film 13 include, for example, various metal (such as chromium, aluminum and titanium), nitride (such as chromium nitride, aluminum nitride and titanium nitride) and oxide (such as chromium oxide, aluminum oxide and titanium oxide). Among them, the material preferably contains at least one element of chromium, aluminum and titanium. For example, in addition to chromium metal, aluminum metal and titanium metal; oxide and nitride thereof and mixture thereof are preferable. In this manner, when at least one element of chromium, aluminum and titanium is contained in protective film 13, it is characterized that these elements are oxidized by heating in the atmosphere to form a stable layer containing oxide on the surface. Since these oxides have small standard free energy of formation (standard Gibbs' energy of formation) and are very stable, there is an advantage of hardly perform a reaction even when being brought in contact with high temperature molten glass. Among them, since oxide of chromium is particularly stable, it is specifically preferable to provide protective film 13 containing a chromium element.

The thickness of protective film 13 is generally preferably not less than 0.05 μm in view of restraining oxidation of plated layer 12. However, there is a case of easy generation of defects such as peeling when protective film 13 is excessively thick. Therefore, the thickness of protective film 13 is preferably 0.05-5 μm and more preferably 0.1-1 μm.

(Step S108: Roughening of Protective Film Surface)

Next, the surface of protective film 13 is subjected to roughening (FIG. 2f). This step is not necessarily indispensable; however, by roughening the surface of protective film 13, it is possible to prevent generation of residual air in a molded glass article due to sealing of air between glass and protective film 13 at the time of compression molding.

A method for roughening is not specifically limited and may be appropriately selected from various etching or blast treatments. In view of easy formation of uniform roughness, wet etching or dry etching is preferable.

The surface of protective film 13 after etching is preferably made to have an arithmetic mean roughness (Ra) of 0.005 μm and a mean length of a roughness curve element (RSm) of 0.5 μm. Thus, it is possible to effectively restrain generation of residual air in a molded glass article. Further, in view of restraining the surface roughness of a molded glass article, the arithmetic mean roughness (Ra) is preferably not more than 0.05 μm and more preferably not more than 0.03 μm. Herein, the arithmetic mean roughness (Ra) and the mean length of a roughness curve element (RSm) are parameters defined in JIS B 0601:2001. Measurement of these parameters is performed by use of a measuring system having a spatial resolution of not more than 0.1 μm such as an AFM (Atomic Force Microscope).

(Method for Manufacturing Molded Glass Article)

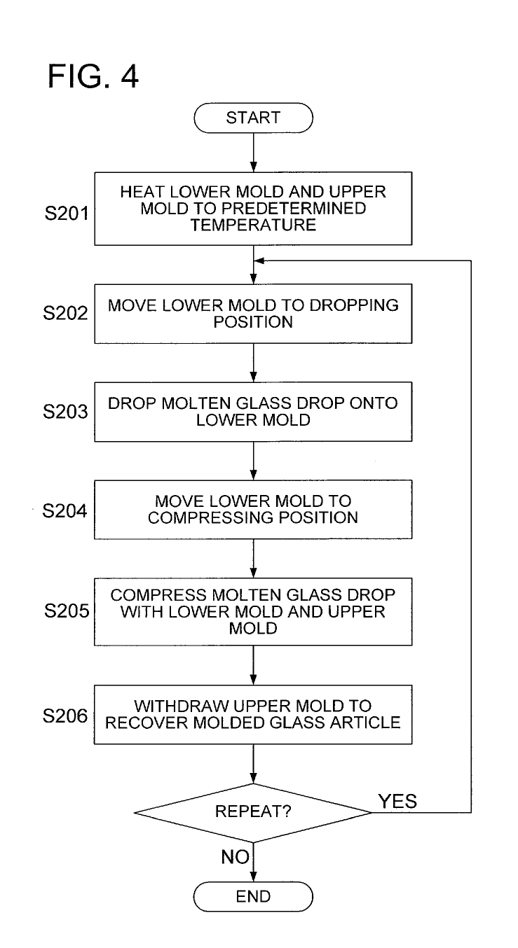

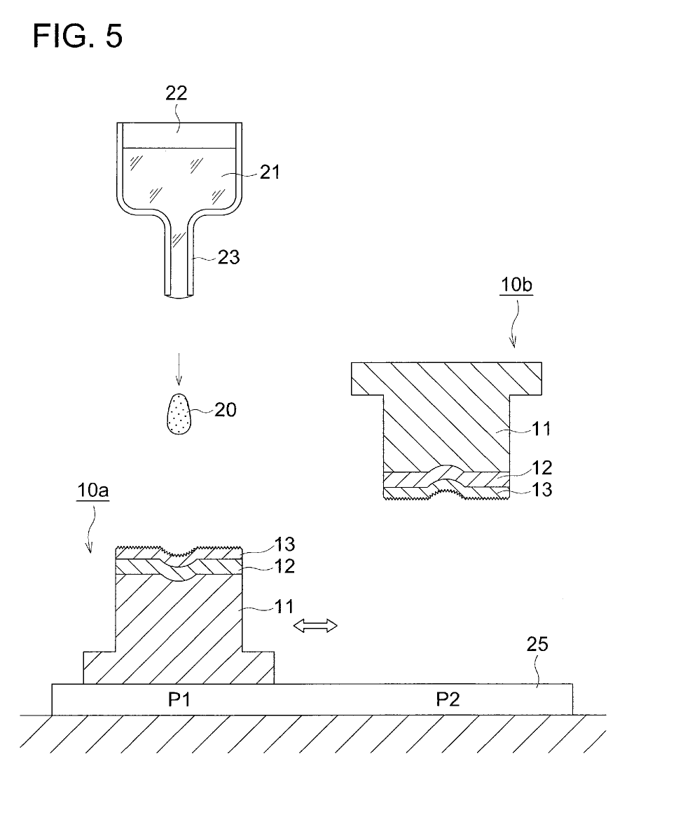

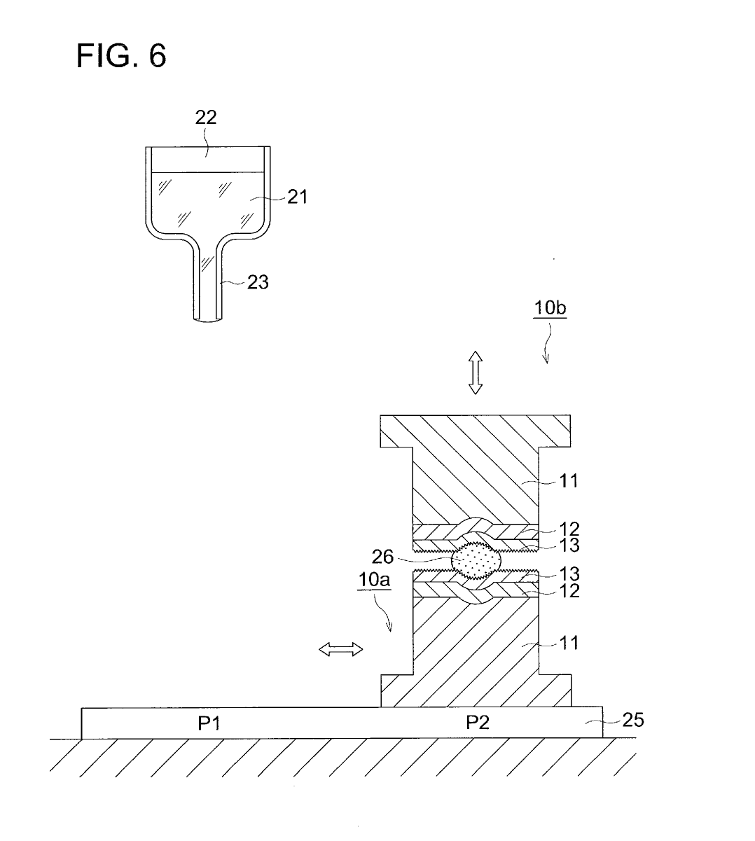

Next, a method for manufacturing a molded glass article of the embodiment will be explained in reference to FIGS. 4-6. FIG. 4 is a flow chart to show an example of a method for manufacturing a molded glass article. Further, FIGS. 5 and 6 are schematic drawings of an apparatus for manufacturing a molded glass article utilized in the embodiment. FIG. 5 shows the state in the step (S203) to drop molten glass drop on an lower mold, and FIG. 6 shows the state in the step (S205) to compress the dropped molten glass drop with an lower mold and an upper mold.

The apparatus for manufacturing a molded glass article shown in FIGS. 5 and 6 is provided with melting bath 22 to store molten glass 21, dropping nozzle 23 which is connected to the bottom of melting bath 22 and drops molten glass drop 20, lower mold 10a (a first molding die) to receive dropped molten glass drop 20, and upper mold 10b (a second molding die) to perform compression molding of molten glass drop 20 together with lower mold 10a. A molding die prepared by a manufacturing method of a glass molding die according to the embodiment can be utilized as at least one of lower mold 10a and upper mold 10b. The case of a molding die prepared by a manufacturing method of a glass molding die according to the embodiment being utilized as both lower mold 10a and upper mold 10b will now be explained as an example. Lower mold 10a and upper mold 10b each are provided with plated layer 12 and protective film 13 on substrate 11 and the surface of protective film 13 is roughened. Herein, as described above, protective film 13 is not necessarily indispensable, and the surface of protective film 13 may be utilized without being roughened.

Lower mold 10a and upper mold 10b are configured so as to be heated at a predetermined temperature by a heating means which is not shown in the drawing. As a heating means, a heating means well known in the art can be appropriately selected and used. For example, a cartridge heater which is utilized being buried in the interior, a sheet type heater which is utilized being in contact with the outside, an infrared heater and a high frequency induction heater can be utilized. A constitution which enables control of each temperature of lower mold 10a and upper mold 10b independently is preferable. Lower mold 10a is configured so as to be movable along guide 25 between the position to receive molten glass drop 20 (dropping position P1) and the position to perform compression molding (compression position P2). Further, upper mold 10b is configured so as to be movable in the direction to compress molten glass drop 20 by a drive means which is not shown in the drawing.

In the following, each step of a manufacturing method for a molded glass article will be described in order, according to the flow chart shown in FIG. 4.

First, lower mold 10a and upper mold 10b are heated at a predetermined temperature (step S201). As the predetermined temperature, appropriately selected is a temperature enabling formation of a good transferred surface of a molded glass article by compression molding. Heating temperatures of lower mold 10a and upper mold 10b may be the same or different. Practically, since a suitable temperature may depend on various conditions such as a material and size of a die for molding glass, it is preferable to experimentally determine a suitable temperature. Generally, it is preferably set to a temperature of from Tg −100° C. to Tg+100° C. when a glass transition temperature of utilized glass is Tg.

Next, lower mold 10a is moved to dropping position P1 (step S202) and molten glass drop 21 is dropped from dropping nozzle 23 (step S203) (refer to FIG. 5). Dropping of molten glass drop 20 is performed by heating dropping nozzle 23, which is communicated to meting bath 22 to store molten glass 21, at a predetermined temperature. When dropping nozzle 23 is heated at a predetermined temperature, molten glass 21 stored in melting bath 22 is supplied to the top portion of dropping nozzle 23 by its own weight and is held in a liquid drop form due to surface tension. When molten glass held at the top portion of dropping nozzle 23 grows to have a certain mass, it is naturally separated from dropping nozzle 23 by gravity to drop downward as molten glass drop 20.

The mass of molten glass drop 20 dropped from dropping nozzle 23 can be adjusted by the outer diameter of the top portion of dropping nozzle 23, and it is possible to drop molten glass drop 20 of approximately 0.1-2 g although it depends on a kind of glass. Further, molten glass drop 20 dropped from dropping nozzle 23 may be once made to collide against a member having penetrating micro pores to pass through the penetrating micro pores, whereby micronized molten glass drops may be dropped on lower mold 10a. By utilizing such a method, since molten glass drop, for example, as minute as 0.001 g can be prepared, it is possible to manufacture a more minute glass gob compared to the case of directly receiving molten glass drop 20 dropped from dropping nozzle 23. Herein, the interval of dropping of molten glass drop 20 from dropping nozzle 23 can be finely adjusted by adjusting the inner diameter, length and heating temperature of dropping nozzle 23.

The kind of glass utilized is not specifically limited and glass well known in the art can be appropriately selected and used depending on the application. For example, optical glass such as borosilicate glass, silicate glass, phosphate glass and lanthanum type glass is listed.

Next, lower mold 10a is moved to compressing position P2 (step S204) and upper mold 10b is moved downward, whereby molten glass drop 20 is subjected to compression molding with lower mold 10a and upper mold 10b (step S205) (refer to FIG. 6). Molten glass drop 20 received by lower mold 10a is cooled by heat radiation through the contact surface with lower mold 10a and upper mold 10b and solidified to be molded glass article 26. When molded glass article 26 is cooled to a predetermined temperature, upper mold 10b is shifted upward to release pressure. Generally, pressure is preferably released after cooling to a temperature near Tg of glass, although it depends on the kind of glass, the size, form and required precision of molded glass article 26.

The load applied to compress molten glass drop 20 may be always constant or varied with time. The magnitude of the load applied may be appropriately set depending on the size of molded glass article 26 to be manufactured. The drive means to vertically move upper mold 10b is not specifically limited and a drive means well known in the art such as an air cylinder, a hydraulic cylinder and an electric cylinder employing a servo motor can be appropriately selected and used.

Thereafter, upper mold 10b is withdrawn upward and molded glass article 26 having been solidified is recovered (step S206) to complete manufacture of molded glass article 26. Then, for successive manufacture of molded glass article 26, lower mold is moved to dropping position P1 again (step S202) and the following steps are repeated. Herein, a method for manufacturing a molded glass article of the embodiment may includes steps other than those explained here. For example, provided may be a step to inspect the form of molded glass article 26 before recovering molded glass article 26, or a step to clean lower mold 10a and upper mold 10b after recovering molded glass article 26.

As described above, since lower mold 10a and upper mold 10b utilized in the embodiment is subjected to a finish machining to be a desired final shape after crystallization of plated layer 12 has progressed in the second thermal treatment process, shape change by heating in the manufacturing process of a molded glass article and to manufacture a molded glass article having high shape precision over a long time is restrained. Further, since a glass molding die whose surface roughness has been decreased by a finish machining is utilized, it is possible to manufacture a molded glass article having a small surface roughness.

Herein, described exemplarily is a method (a liquid drop molding method) for manufacturing a molded glass article in which a dropped molten glass drop is received by an lower mold and subjected to compression molding by use of an lower mold and an upper mold; however, a molding die prepared by the method for manufacturing a glass molding die of the embodiment can be also suitably utilized for manufacturing a molded glass article by other method. For example, it can be preferably utilized also in a method (a reheat press method) in which a glass preform having a predetermined mass and shape is prepared in advance and the glass preform is heated together with a molding die to perform compression molding.

In the embodiment, since a rough machining to form a shape similar to the desired final shape is performed before hardening of a plated layer by the second thermal treatment process, the cutting amount of a plated layer at the time of finish machining to be performed after hardening is decreased to restrain wear of a bit. Further, since a finish machining to form the desired final shape is performed after crystallization of a plated layer has progressed by a high temperature thermal treatment process, the finished shape is restrained from deforming in the following processes, and the surface roughness which increased due to crystallization is decreased by a finish machining. Therefore, a glass molding die having high shape precision and small surface roughness is provided. Further, a molded glass article having high shape precision and small surface roughness is prepared by molding glass material by using such a glass molding die.

Molded glass article 26 manufactured by a manufacturing method of the embodiment can be utilized as various optical elements such as a image pickup lens of a digital camera, an optical pickup lens of a DVD and a coupling lens for optical communication. Further, it can be also utilized as a glass preform which is utilized for manufacturing various optical elements by means of a reheat press method.

What is claimed is:

1. A method of manufacturing a glass molding die, the method comprising the steps of:
forming a plated layer made of Ni—P plating on a surface of a substrate;
rough machining the plated layer to have a shape similar to a desired final shape;
thermal treating the rough machined plated layer to harden; and
finish machining the hardened plated layer to have the desired final shape.

2. The method of claim 1, wherein a maximum cutting amount of the plated layer in the step of rough processing is greater than a maximum cutting amount of the plated layer in the step of finish machining.

3. The method of claim 2, wherein the maximum cutting amount of the plated layer in the step of finish machining is in a rage of 0.6 μm to 5 μm.

4. The method of claim 1, wherein a temperature of the thermal treating in the step of thermal treating is in the range of 300° C. to 550° C.

5. The method of claim 1, wherein a Vickers hardness of the plated layer after the step of thermal treating is 900HV0.1 or higher.

6. The method of claim 1, comprising, before the step of rough machining, the step of:
preliminarily thermal treating the plated layer at a first temperature lower than a second temperature in the step of thermal treating.

7. The method of claim 6, wherein the first temperature is in a range of 150° C. to 250° C.

8. The method of claim 6, wherein a Vickers hardness of the plated layer after the step of preliminarily thermal treating is 700HV0.1 or lower.

9. The method of claim 1, comprising, after the step of finish machining, the step of:
forming a protective layer containing chrome on a surface of the plated layer.

10. The method of claim 9, comprising the step of:
roughening a surface of the protective layer by etching.

11. A method for manufacturing a molded glass article, the method comprising the step of:
compression molding glass material to form the molded glass article, using a glass molding die,
wherein the glass molding die is manufactured by a method, for manufacturing a glass molding die, including the steps of:
forming a plated layer made of Ni—P plating on a surface of a substrate;
rough machining the plated layer to have a shape similar to a desired final shape;
thermal treating the rough machined plated layer to harden; and
finish machining the hardened plated layer to have the desired final shape.

12. A method for manufacturing a molded glass article, the method comprising the steps of:
dropping a molten glass drop on a first molding die; and
compression molding the dropped molten glass droplet with the first molding die and a second molding die which faces the first molding die,
wherein at least one of the first molding die and the second molding die is manufactured by a method, for manufacturing a glass molding die, including the steps of:
forming a plated layer made of Ni—P plating on a surface of a substrate;
rough machining the plated layer to have a shape similar to a desired final shape;
thermal treating the rough machined plated layer to harden; and
finish machining the hardened plated layer to have the desired final shape.
